(19) United States
(12) Patent Application Publication
(10) Pub. No.: US 2012/0095577 A1
(43) Pub. Date: Apr. 19, 2012

(54) Real Time Fantasy Game Engine

(76) Inventor: Richard Golding, Pietermaritzburg (ZA)

(21) Appl. No.: 13/269,493

(22) Filed: Oct. 7, 2011

Related U.S. Application Data
(60) Provisional application No. 61/391,468, filed on Oct. 8, 2010.

(51) Int. Cl. G06F 19/00

(52) U.S. Cl. 700/91

(57) ABSTRACT

A system inputs predictions about plays in athletic competitions or other live or recorded events before the events are broadcast or viewed. A related system inputs information about the plays or events in real time. The system uses the predictions by the users to award points to correct predictions in a predetermined manner. The result is a game of skill that can be played using a computer or mobile computing device. Alternatively, the game can be played without computers, but rather by players manually signaling predictions on a board and one or more operators awarding the points, or a hybrid of the computer and non-computer modes of play.

### RELATED APPLICATIONS

The present application is related to the provisional patent 61/391,468

### TECHNICAL FIELD

The described technology is directed generally to games in which players try to predict situations that will happen momentarily on a real time athletic competition or other event and, more particularly, to games in which players try to predict plays by players in sporting events throughout the course of the game play.

### BACKGROUND OF INVENTION

Fantasy sports and fantasy leagues are well known and established as a popular form of entertainment. Traditionally, a fantasy game is only related to a live game in the sense that players are awarded points from the plays executed by the athletes during the game. The players “draft” real-life athletes through a myriad of systems and rules predefined on their particular league and subsequently form a team with these players. Typically, real-life sporting events happen, and players are awarded cumulative points afterwards, relating to plays performed in these real-life athletic competitions during the previous week by the athletes composing their particular “roster” in their fantasy team.

At the time athletic competitions are in progress, there is no interaction with the fantasy games. Players simply sit back and watch as athletes that may or may not impact the scores of the fantasy player teams perform plays.

A major problem with a typical fantasy game is that it provides no interactivity at the time an athletic competition is in progress. The experience is completely passive.

Another major problem is that playing the typical fantasy games require actions by the players far in advance. Players are generally not allowed to draft or replace their “roster” in response to changing conditions while the game is in progress such as injuries, substitutions changes in weather, etc. They must do it in advance of the actual games. Thus, there's generally no way to join a fantasy game while the actual athletic competitions are in progress.

A related problem to the above mentioned issue is that fantasy players are required to monitor real-life information about the players currently drafted into their teams to increase their chances of winning. For example, if a fantasy player has an active roster athlete that is injured, there is no chance that player will add any points to their score because the player will be benched and not be participating in the athletic competitions.

Traditional fantasy games are also limited to competition between a small number of players within a league, usually but not necessarily 12 or less. Since real-life athletes can only be “drafted” into a single fantasy player's roster, there are in practice limits to how many effective teams can exist in the same league and sharing the pool of viable athletes that are likely to actually participate in plays and bring them points.

Yet another drawback of traditional fantasy games is that the winner of a particular fantasy league is generally only determined after the completion of an entire season. This requires a level of commitment that prevents many people from joining in the game, and also fails to provide a more immediate fulfilling experience.

Similar games exist outside of athletic competitions. Fantasy games have been created around other events such as reality-TV shows, movie celebrities, and even politics. Although the rules and events are different, the concept is still the same in that a fantasy player “drafts” people in advance into their teams and real-life actions such as winning a competition, starring in a blockbuster movie, or passing a bill in Congress award points to the fantasy player.

It would be desirable if a fantasy game could be developed that allows players to play a game relating to the live athletic competition or event that allows interactivity as the competition or event is in progress; that does not require players to draft their “roster” in advance, nor to monitor all players in their “roster”; that allows for continuing adjustment of the fantasy play style immediately as the situation changes in real-time; that allows a larger number of simultaneous players in competition with each other; and finally, that provides a clear winner or winners in a more timely, compelling and rewarding manner.

### SUMMARY OF THE INVENTION

In fulfillment of the above objectives, the present invention provides a system and method for carrying out a type of fantasy game that happens simultaneously to a real-time athletic competition or other real-time event. It significantly enhances the interactivity and appeal of a fantasy game, eliminates the need for drafting a roster before a game starts, allows for play-by-play adjustment of playing strategy according to the progress and changing condition, and provides winners of the fantasy game immediately after the current athletic competition or event period is finished.

The method of the present invention involves a fantasy competitive game between any number of fantasy players relating to an athletic competition or other event, in full or in part, preferably but not necessarily broadcast live on television or other media.

Before the real-life plays happen on the athletic competition or event, fantasy players use the system of the present invention to predict the details about types of plays that they think will happen. Predictions are made by assigning points, or tokens, to positions on a board corresponding to details and types of plays. Players may choose one or a multitude of predictions, and assign points to each one according to the strategy they think will yield most gains, as well as predetermined rules for their particular embodiment of the game.

As the play happens in real-life, a game operator or automated system records details about that play. Then, players that correctly predicted it get winnings in proportion to the points they had assigned to the predictions, as well as a multiplier that is in directly proportional relation to to how specific a prediction was.

As the game progresses, players accrue points from correct predictions, and can further use these points to accrue more points from more correct predictions. In some embodiments, there are limits to how many points a player may place in one single round of prediction.

The result of this game dynamic is a fantasy game of skill where players attempt to correctly predict the play by play strategy of a the athletic competition. Players use their knowledge of the team, athletic competition rules, on-field players, coaching staff, weather conditions, situational awareness, etc. to arrive at what they consider the most likely selection(s).

At the end of the competition of fantasy play, the player or players with most points win the game. In some embodiments, multiple winners may be considered, or special winning categories can be awarded based on aggregate winnings, single round play performance, or other predetermined conditions.

The actual sporting events that most lend themselves to this type of game are football, rugby, baseball and cricket, because of the clear nature of the plays on the field. However, mechanisms can be put in place to allow other sports to be played, such as but not limited to soccer, basketball, hockey and lacrosse. Likewise, non athletic events can be modeled in such a way as to allow playing of this type of fantasy game. These variations will become apparent to those skilled in the art after reviewing the appended drawings and detailed description that follows.

### BRIEF DESCRIPTION OF THE DRAWINGS

FIG. 1 is a high-level block diagram illustrating selected components of a computer-based game, according to some embodiments.

FIG. 2 is a flow diagram illustrating the process of the game system described in this application.

FIG. 3 is a flow diagram illustrating the process of the game system described in this application.

FIG. 4 is a flow diagram illustrating the data entry process that allows the game to be played.

FIG. 5 is a display diagram of an embodiment of a game board, such as could be used to play the fantasy game relating to a football athletic competition.

### DETAILED DESCRIPTION OF THE PREFERRED EMBODIMENTS

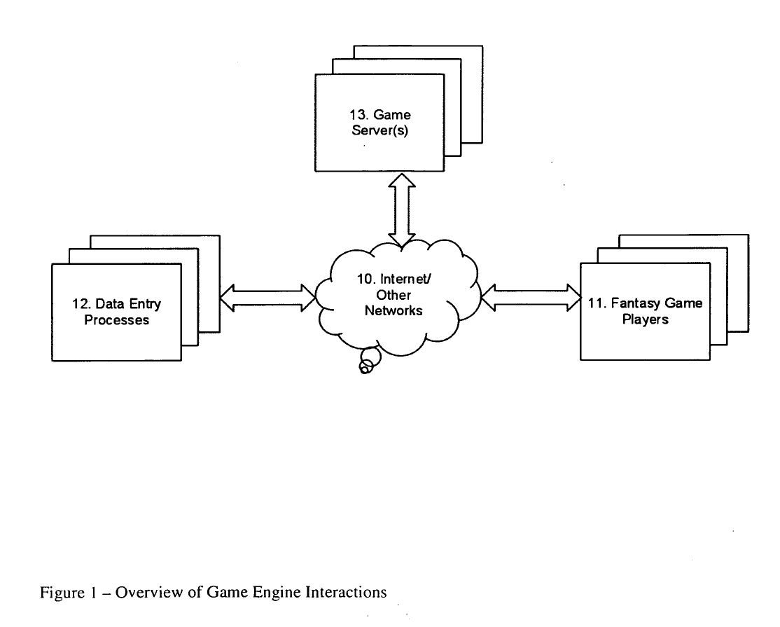

Reference is made first to FIG. 1 for an overview of an embodiment of the present invention. FIG. 1 represents in schematic form the various electronic, digital and network components that would facilitate the fantasy sports competition. The Fantasy Game Players 11 represents the systems through which fantasy players input their predictions and view information about the state of the game, review the predictions made by themselves and by other fantasy players, and view results and points gained, these systems are such as computer systems or mobile computing devices. The Data Entry Processes 12 represent the computer systems or mobile computing devices through which either manual or automated processed input detailed information about the plays or events in real life athletic competitions. The Game Server(s) 13 is comprised of one computer system or a multitude of computer systems working together to carry out the processing of the fantasy game method of play through access by the various Fantasy Game Players 11, as well as the processing of the data about the plays in athletic competitions through the Data Entry Processes 12. Access is carried out by means of a network 10 which, in the preferred embodiment, comprises access by way of the Internet, but could be carried out in any sort of electronic network.

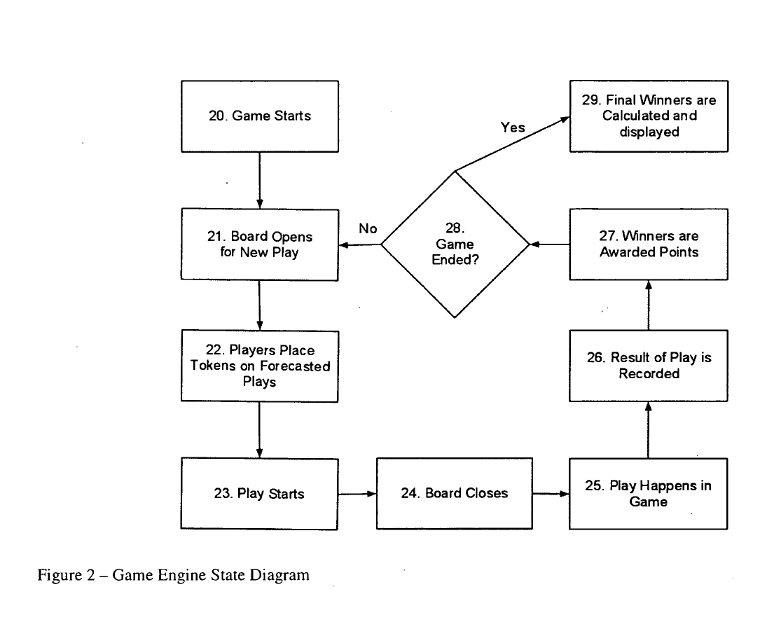

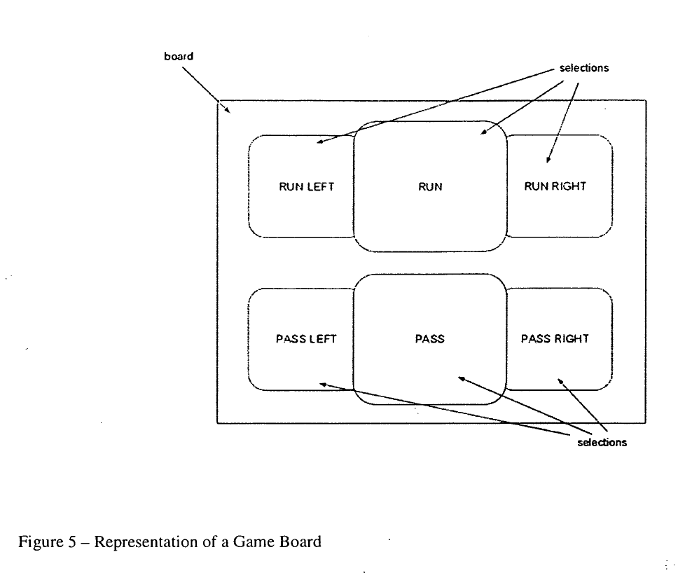

Reference is now made to FIG. 2 for a detailed description of the steps associated with playing the fantasy game described by the present invention. At step 20, the fantasy game starts, before, in conjunction, or slightly after the real life athletic competition or other event starts. In step 21, as the real life athletes are preparing to or have started to prepare for playing, the fantasy game board opens for a new play. In step 22, the fantasy game players place tokens or assign points to positions on a game board such as described below, on FIG. 5. Step 23 represents the beginning of the real life athletic game situation period or play. In one embodiment, the fantasy game board then closes as per step 24 and players are not allowed to signal any more predictions. Step 25 signals the play happening in the real life athletic competition. Such situation period, or play, will typically undergo completion and ruling, and is then recorded by automated systems or by data input such as Data Entry Processes 12 mentioned in FIG. 1. In step 27, processes such as these encompassed by the Game Servers 13 in FIG. 1 award the correct winnings to players. These winning are calculated by predetermined formulas that take into account the accuracy of the prediction. For example, a “Run” in a football game is easier to predict than a more specific “Run to the Right”. Consequently, players who predicted a run to the right will, in a preferred embodiment, receive higher winnings than other players who just predicted a “run”. Such winnings are, in a preferred embodiment, also proportional to a number of points or tokens that a player assigned to the prediction. Still in FIG. 2, step 28 shows how the game carries on back to another subsequent situation period if the game is still in progress, or goes to a final step 29, where final winnings are calculated and winners assigned. In a preferred embodiment, the winners are selected by total point count, that is, the number of points or token values each fantasy player has after assigning some or all of their original points to predictions. In another embodiment, extra winning categories may be predetermined, such as, for example, fantasy player who made most points in one single play, fantasy player who made most correct forecasts in a single play, or fantasy player who made most points in a single athletic competition period such as a quarter game.

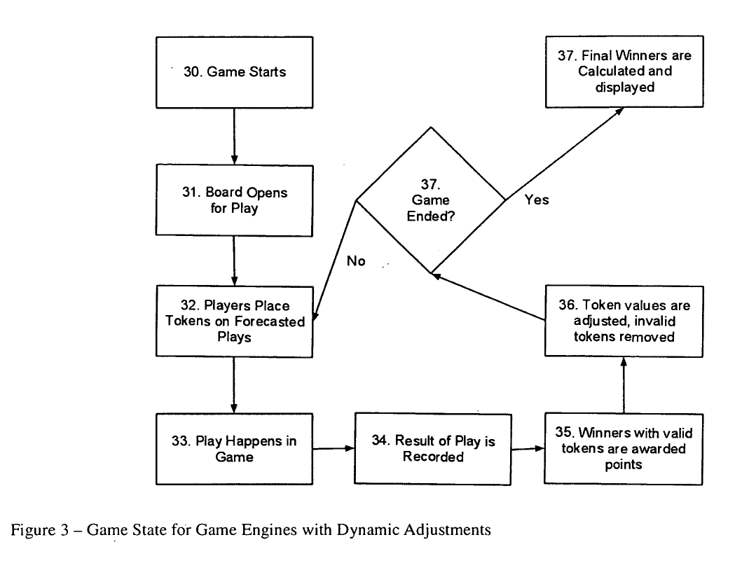

In contrast to FIG. 2, FIG. 3 offers a detailed description of the steps associated with playing another embodiment of the fantasy game described by the present invention relating to athletic competitions which do not have clear situation periods or play starts. Some examples of such sports are soccer, basketball and hockey, but the list is not limited to such sports, and the distinction is clear to any skilled in the field. At step 30, the fantasy game starts, before, in conjunction, or slightly after the real life athletic competition or other event starts. In step 31, as the real life athletes are preparing to or have started to prepare for playing, the fantasy game board opens for play. In step 32, the fantasy game players place tokens or assign points to positions on a game board such as described below, on FIG. 5. Step 33 signals the play happening in the real life athletic competition. Such play will in one embodiment be part of ongoing plays and not necessarily have a precise start and end or interrupt an athletic competition in progress. In such a scenario, the tokens assigned by players in step 32 are only valid while certain conditions are met and lose their validity or reduce in point value after these conditions are not existent anymore. These conditions are predetermined dependent on the specific sport being followed. For example, in an embodiment of the fantasy game for basketball, a token placed on a “free throw shot” position will only be valid when the current free throw shot play is being played, and will lose their validity as soon as the ball leaves the free throw area. Such events are arbitrary and can be preselected by one skilled in the knowledge of the rules of specific sports. In step 34, the plays are then recorded by automated systems or by data input such as Data Entry Processes 12 mentioned in FIG. 1. In step 35, processes such as these encompassed by the Game Servers 13 in FIG. 1 award the correct winnings to players with tokens valid as per the process mentioned above. Step 37 shows how the game carries on back to continuing play if the game is still in progress, or goes to a final step 37, where final winnings are calculated and winners assigned.

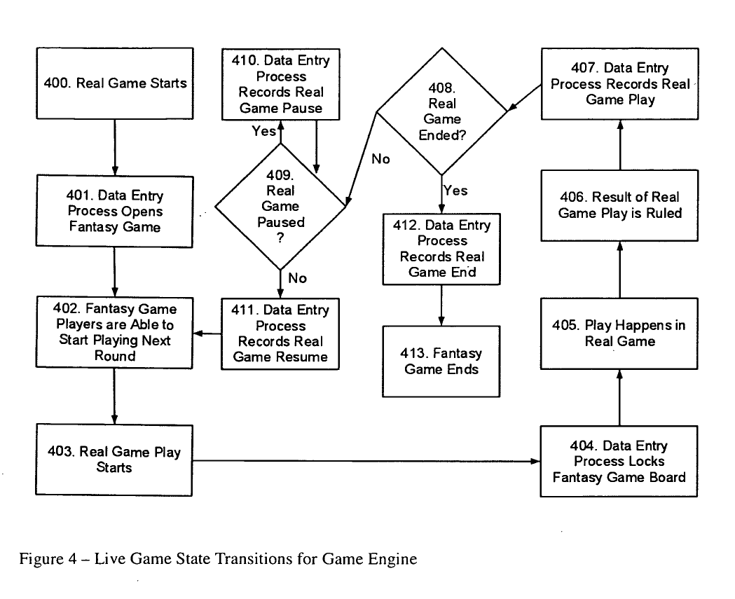

FIG. 4 represents a detailed description of the steps associated with the data entry process for the fantasy game described in this invention. As the real game starts as illustrated by step 400, an automated system or other data entry process opens the game in step 401, players start to be able to play the fantasy game described in the present invention as per step 402. When the real life athletic information is input about the plays in athletic competitions to a system such as Data Entry Processes 12 described in FIG. 1. In one embodiment, as the next play happens, the board is locked as per step 404, and fantasy players wait after having placed their predictions on the board. As plays happen in the athletic competition as illustrated in step 405 and in one embodiment plays are finalized and ruled upon as per step 406, this information is added to the system of this invention in step 407. Step 408 shows how the game carries on back to another round of play if the game is still in progress, or is paused for things like half-times or commercial breaks, described by step 409. When such events happen, this information is added by automated processes or other means to the system in step 410. A pause in the progress is monitored until game is resumed and this signalled and recorded in step 411. Alternatively, if the automated or other data entry processes in step 408 signal that the real life athletic competition has ended or, in one embodiment, the predetermined amount of fantasy game play should end, this is recorded in step 412 and the fantasy game goes to a final step 413, where final winnings are calculated and winners assigned.

Reference is now made to FIG. 5. It represents an embodiment of a board 50 for a fantasy game such as described in this invention, relating to a game of football. When a fantasy game is in progress, players can place tokens representing points on the different selections 52 and 53, representing the predictions they are making before the plays happen in the real life athletic competitions. For example, a player could place tokens on “Pass” 57, signalling that they believe in the coming play, an athletes will throw the ball and pass it to a fellow player. A different selection would be, for example, “Pass right” 59, signalling that they believe an athlete not only will throw the ball, but throw it to another player to their right. In one embodiment, the same player can place multiple tokens on the board, such as on “Pass” 57 and “Pass left” 58 for the same upcoming play prediction. Likewise, as it will be apparent to anyone skilled in the art, it may be advantageous to have embodiments of the games where players may be limited to only one token at a time, or in other embodiments a plurality of tokens, with or without limitations on the amount of tokens that can be placed during the progress of the fantasy game plays. In one embodiment, when a play in an athletic competition ends and winnings are awarded, the winnings are proportional to how difficult it is to predict the plays. As it is apparent to someone skilled in the art, certain predictions are easier than others. For example, in a football game such as related to FIG. 5, a “Run” 54 is much easier to predict than a “Run right” 56. Since this necessarily implies that there's less of a chance of getting a “Run right” 56 prediction correctly, it follows logically that in some embodiments the winnings paid to a fantasy player who correctly predicted it should be higher than someone who simply predicted a “Run” 54. Also, in one embodiment, fantasy players are allowed to place one or more tokens in the same position on the board, and it logically follows to those skilled in the art that the winnings should be proportional to the amount of tokens or points placed on the correctly predicted positions.

The example board on FIG. 5 is a simple example of an embodiment of a board for play, but this invention is not limited to such an example. Even for the same type of athletic competition, football, there are certainly many more possibilities of boards. For different sports, as it is apparent to anyone skilled in the art, the types of possible predictions would be different. Types of predictions and plays include but are not limited to: passes, runs, directionality, length, offensive plays, defensive plays, scoring events, out of bounds, fowls, etc. Moreover, embodiments of boards may be designed for operations on multiple media or devices, such as but not limited personal computers, video arcade machines, mobile computing devices, cell phones, etc., or even non-electronic media such as, in one embodiment, a board game to be played manually by manually placing physical tokens on a physical board as a sporting event is watched.

What is claimed:

1. A method for electronic game play comprising the following steps:
(a) initiating electronic contact by the fantasy game player to a remote server;
(b) displaying an electronic fantasy game board with predefined game options;
(c) communication with the fantasy game players to make predictions in regard to a specific athletic competition;
(d) restricting the game participants actions until the start of a situation period within the event,
permitting the fantasy game player to make predictions on the fantasy game board in direct relation to the situation period of the real life athletic competition;
(e) receiving the game player's predictions on a Game Server;
(f) processing and storing the results of each game situation period in the Game Server(s) for processing fantasy game play;
(g) storing the predictions of each game player for the situation period within the event;
(h) closing the game participants ability to make elections;
(i) judging the result of a particular situation period within the event;
(j) updating the score of the situation of the event;
(k) distributing the situation period's results to all game participants;
(l) storing the results of each game participant prediction of the situation period with in the event and associated winnings;
(m) restarting the sequence of game play to the event's next situation period;
(n) finalizing a game, calculating, storing and distributing final winning results.

2. The method for electronic game play of claim 1 where the remote server site comprises an Internet site.

3. The method for electronic game play of claim 1 where the remote server site comprises a hosted application server.

4. The method for electronic game play of claim 3 where the remote server site comprises a data storage server comprising both memory resident and secondary disk storage.

5. The method for electronic game play of claim 3 where the remote server site comprises a direct data push technology for publishing information from the application server to remote clients.

6. The method for electronic game play of claim 1 where the remote server site comprises a combined Internet site and hosted application server.

7. The method for electronic game play of claim 1 the communication mechanism between fantasy player and remote server is accomplished through digital network including but not limited to wired and wireless networks.

8. The method for electronic game play of claim 7 where the communication sequences are delivered from the application server as referenced in claim 3 via direct connection technology such as, but not limited to TCP/IP tunnel, websocket, socket.

9. The method for electronic game play of claim 7 where the communication sequences are delivered from the application server as referenced in claim 3 via remote pull connection technology such as long poll requests and timer based pull TCP/IP connection.

10. The method for electronic game play of claim 7 where the communication sequences is delivered in singular or combination of claim 8 and or claim 9.

11. The method for electronic game play of claim 1 where the electronic identification is a sequence of characters that uniquely identify the game participant through user id and password.

12. The method for electronic game play of claim 1 where the electronic game board is an image clearly delineated into game play options.

13. The method for electronic game play of claim 12 where the electronic game board allows for the predictions in game option selections in singular or plural.

14. The method for electronic game play of claim 12 where the electronic game board is comprised of, but not limited to a collection of images and or sequences of vector graphics

15. The method for electronic game play of claim 1 where the selection is a numeric value placed on a game option selection in singular or plural.

16. The method for electronic game play of claim 1 where the selection comprises groupings of selection values, such that game participants can make game selections in singular or plural.

17. The method for electronic game play of claim 1 where the restriction of game participation is made through a sequence of flags to mimic the athletic event action.

18. The method for electronic game play of claim 1 where the fantasy player elections as entered into the game board is delivered across the network of claim 7 to the remote server.

19. The method for electronic game play of claim 1 where the application server as referenced in claim 3 maintains a data structure where the plurality of predictions from fantasy players over time are stored and organized.

20. The method for electronic game play of claim 1 where the communication from the application server as referenced in claim 3 is made via the communication path referenced in claim 7 to the fantasy game player.

21. The method for electronic game play of claim 1 with the ability to temporarily disable the electronic game board as referenced in claim 12.

22. The method for electronic game play of claim 1 where interstitial images and vector drawings are presented, including but not limited to text during such disabling as referenced in claim 21.

23. The method for electronic game play of claim 1 with the judgment of the correct outcome of the athletic situation and identification as to which segment of the electronic game board is correct is displayed on the game board.

24. The method for electronic game play of claim 1 with the systematic process of identifying all the correct fantasy player predictions stored in claim 18 and applying a game engine to correctly reward these elections.

25. The method for electronic game play of claim 1 with the display of correct predictions and distribution of winnings as referenced in claim 24 back to the fantasy game players.

26. The method for electronic game play of claim 1 with a representation of correct elections as determined in claim 24 on the electronic game board as referenced in claim 12.

27. The method for electronic game play of claim 26 where the representation is illustrated by, but not limited to images, vector graphics and or textual cues.

28. The method for electronic game play of claim 1 where the value of the points identified by the fantasy player in game board election as referenced in claim 12 is updated to reflect the judgment made in claim 23.

29. The method for electronic game play of claim 1 where the game situation can be restarted upon the start of the next period in the athletic event.

30. The method for electronic game play of claim 29 where the restart of sequences is delivered from the application server as referenced in claim 3 and delivered via the communications referenced in claim 7.

31. The method for electronic game play of claim 1 with the completion of temporal segments of the game play including, but not limited to, in singular or plural, end of play, end of quarter, end of period, end of half, end of full time, end of extended time, end on injury time, end of bonus time.

32. The method for electronic game play of claim 1 where the final computation of scores is made at predefined temporal events as referenced in claim 31.

33. The method for electronic game play of claim 32 with the addition of all points accumulated during event periods as referenced in claim 31.

34. The method for electronic game play of claim 32 where the final computation of fantasy player rank is made at predefined event periods as referenced in claim 31.

35. The method for game play of claim 1 where the representation of fantasy player predictions, the rulings and the results are placed on physical, non electronic media through mechanical or human interaction.

36. The method for game play of claim 1 where the representation of fantasy player predictions rulings and results are placed on a combination of physical, non electronic and electronic media.
